(19) United States
(12) Patent Application Publication
(10) Pub. No.: US 2022/0118539 A1
(43) Pub. Date: Apr. 21, 2022

(54) BRAZING DEVICE AND BRAZING METHOD

(71) Applicant: HONDA MOTOR CO., LTD., Minato-ku, Tokyo (JP)

(72) Inventors: Satoshi Oyama, Haga-gun, Tochigi-ken (JP); Hiromu Kobori, Haga-gun, Tochigi-ken (JP); Akihiko Takahashi, Haga-gun, Tochigi-ken (JP); Jun Kitagawa, Haga-gun, Tochigi-ken (JP); Shimpei Takahara, Haga-gun, Tochigi-ken (JP)

(21) Appl. No.: 17/424,902

(22) PCT Filed: Sep. 27, 2019
(86) PCT No.: PCT/JP2019/038206

§ 371 Date: Jul. 22, 2021

(30) Foreign Application Priority Data
Jan. 25, 2019 (JP) 2019-010930

(51) Int. Cl. B23K 1/005; B23K 3/08

(52) U.S. Cl. CPC B23K 1/0056; B23K 3/08

(57) ABSTRACT

This brazing device is provided with: a brazing laser beam emission unit; and a removal laser beam emission unit that emits, toward foreign matters, a removal laser beam for removing the foreign matters adhered to the surface of a workpiece when joining the workpiece, wherein the emission direction of the removal laser beam in inclined, with respect to the emission direction of the brazing laser beam, at a predetermined angle in a direction in which the emission position of the removal laser beam approaches the emission position of the removal laser beam.

### TECHNICAL FIELD

The present invention relates to a brazing device and a brazing method for bonding workpieces using brazing.

### BACKGROUND ART

A conventional brazing device is known that bonds a workpiece such as a vehicle plate by solidifying a brazing material after this brazing material has been melted.

JP 2008-119750 A discloses technology for, in order to reduce defects such as holes and unevenness formed in a brazed joining portion, radiating two laser beams that are offset from each other in the progression direction of the brazing. One of these two laser beams melts the filling material (brazing material), and the other performs post-heating treatment.

### SUMMARY OF INVENTION

In JP 2008-119750 A, there is no consideration of reliably removing foreign matter such as soot adhering at or around a bead formed at the bonding portion. Since unevenness occurs in the surface when coating is performed without removing the foreign matter such as soot, it is necessary to add a step of removing the foreign matter with a brush or the like, separately from the bonding step, which increases the number of steps and the cost.

The present invention has been devised in order to solve this type of problem, and has the object of providing a brazing device and a brazing method capable of reliably removing, in a bonding step, foreign matter such as soot generated or adhering at or around a bead and favorably removing foreign matter also at a bonding end portion or the like including a curved portion or bent portion.

A brazing device according to the present invention is a brazing device that bonds a workpiece by melting a brazing material at a prescribed position while moving in a progression direction, the brazing device comprising a brazing laser light radiating unit configured to radiate brazing laser light for melting the brazing material at the prescribed position, and a removal laser light radiating unit configured to radiate removal laser light for removing foreign matter adhered to or generated on a surface of the workpiece when the workpiece is bonded, toward the foreign matter, wherein a radiation direction of the removal laser light toward the workpiece is inclined by a prescribed angle relative to a radiation direction of the brazing laser light toward the workpiece, the prescribed angle bringing an irradiation position of the removal laser light closer to an irradiation position of the brazing laser light.

Furthermore, a brazing method according to the present invention is a brazing method for bonding a workpiece by melting a brazing material at a prescribed position while moving in a progression direction, the brazing method comprising a brazing laser light radiating step of radiating brazing laser light for melting the brazing material at the prescribed position, and a removal laser light radiating step of radiating removal laser light for removing foreign matter adhered to or generated on a surface of the workpiece when the workpiece is bonded, toward the foreign matter, wherein at least at a bonding starting end of the workpiece, a radiation direction of the removal laser light toward the workpiece is inclined by a prescribed angle relative to a radiation direction of the brazing laser light toward the workpiece, the prescribed angle bringing an irradiation position of the removal laser light closer to an irradiation position of the brazing laser light.

According to the brazing device and the brazing method of the present invention, the foreign matter generated in the step of bonding the workpiece can be removed in the same step, and therefore it is possible to reduce the number of steps and the cost compared to a case where a foreign matter removal step is provided separately from the bonding step. Furthermore, since the radiation position of the removal laser light and the radiation position of the brazing laser light can be made as close as possible, the foreign matter can be favorably removed from a wide range of the bonding portion including the bonding end portions of the workpieces.

### BRIEF DESCRIPTION OF DRAWINGS

FIG. 1 is a side view of a brazing device according to an embodiment of the present invention;

FIG. 2 is a front view showing the brazing device of FIG. 1 and a robot, as seen from the front in the progression direction;

FIG. 3 is a diagram corresponding to FIG. 2 in a state where a brazing unit is rotated;

FIG. 4 is a diagram showing an electrical configuration of the brazing device;

FIG. 5 is a schematic diagram showing a blowing direction of argon gas, a foreign matter adhesion area, and a scanning range of removal laser light;

FIG. 6 is a schematic diagram showing the brazing device at a bonding starting end of the workpiece; and

FIG. 7 is a schematic diagram showing the brazing device at a bonding finishing end of the workpiece.

### DESCRIPTION OF EMBODIMENTS

Hereinafter, preferred embodiments of a brazing method according to the present invention will be presented in connection with a brazing device that implements this brazing method, and will be described with reference to the accompanying drawings.

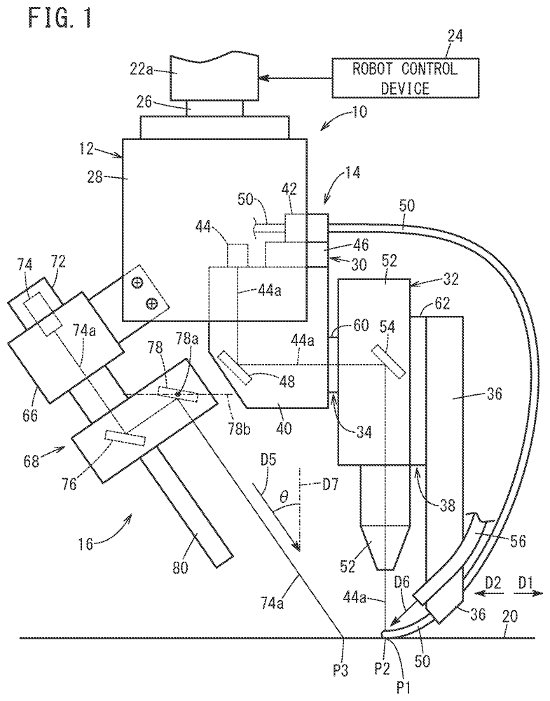

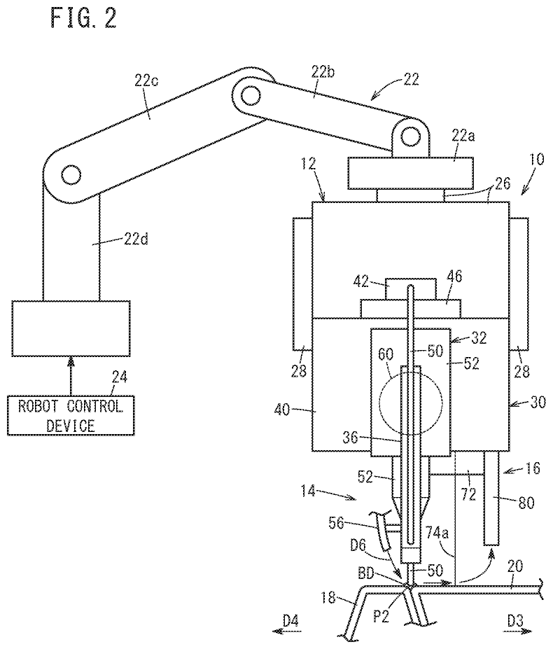

As shown in FIGS. 1 and 2, a brazing device 10 includes a brazing device body 12, a brazing head 14, and a removal laser head 16, and bonds a side panel 18 and a roof panel 20 for a vehicle, serving as workpieces, to each other. The brazing device body 12 is attached to an arm of a robot 22.

The robot 22 is a multi-axis articulated robot, and is provided with a first arm 22a to a fourth arm 22d in order from the tip end. The robot 22 includes a plurality of motors (not shown in the drawings) that drive the respective arms 22a to 22d, and these motors are controlled by a robot control device 24. The brazing device body 12 is attached to the first arm 22a at the tip end. That is, the arms 22a to 22d of the robot 22 hold the brazing device body 12 in a cantilevered state with the fourth arm 22d as a root portion. The root portion is supported on the ground, a pedestal (not shown in the drawings) secured to the ground, or the like.

By driving the plurality of motors described above, the robot control device 24 can drive each arm 22a to 22d to control the position and posture of the brazing device 10 attached to the first arm 22a. The brazing device 10 is moved by the robot 22 in a progression direction D1, which is a direction in which the bonding portion between the side panel 18 and the roof panel 20 extends.

In the description of the present embodiment, the progression direction D1 of the brazing device 10 is forward, a reverse direction D2 of this progression direction is backward, a leftward direction D3 relative to the progression direction is leftward, and a rightward direction D4 relative to progression direction is rightward. Furthermore, when describing the radiation directions of brazing laser light 44a and removal laser light 74a, unless specified otherwise, it is assumed that the brazing device 10 is supported by the robot 22 in the posture shown in FIGS. 1 and 2.

### [Brazing Device Body]

As shown in FIGS. 1 and 2, the brazing device body 12 includes a device attachment portion 26 that is attached to the first arm 22a of the robot 22, and device attachment boards 28 that are attached respectively on the right and left of the device attachment portion 26.

### [Brazing Head]

The brazing head 14 includes a brazing head body portion 30, a brazing unit 32, a brazing unit rotating section 34, a wire guide portion 36, and a wire guide moving portion 38.

The brazing head body portion 30 includes a box-shaped head body case 40 attached to the bottom portion of the front side of the device attachment boards 28 of the brazing device body 12, and a wire feeding device 42 provided on the top side of the head body case 40. Furthermore, the brazing head body portion 30 includes a brazing laser light radiating portion 44 and a brazing control device 46 that are provided on the top side of the head body case 40. The wire feeding device 42 and the brazing laser light radiating portion 44 are controlled by the brazing control device 46.

A head body mirror 48 is provided inside the head body case 40. The head body mirror 48 reflects the brazing laser light 44a, which has been radiated downward from the brazing laser light radiating portion 44 and entered the head body case 40, toward the brazing unit 32 arranged forward therefrom.

The wire feeding device 42 sends out a wire 50 made of brazing material toward a prescribed position P1, includes a pair of rollers (not shown in the drawings) that grip the wire 50, and sends out the wire 50 by rotationally driving these rollers.

The brazing laser light 44a that has been reflected forward by the head body mirror 48 passes through the brazing unit rotating section 34 and then enters the brazing unit 32. The brazing unit 32 includes a box-shaped unit case 52, and a brazing unit mirror 54, which reflects, toward an irradiation position P2 therebelow, the brazing laser light 44a incident thereto, is arranged inside the unit case 52. That is, the brazing unit mirror 54 reflects the brazing laser light 44a downward in the vertical direction.

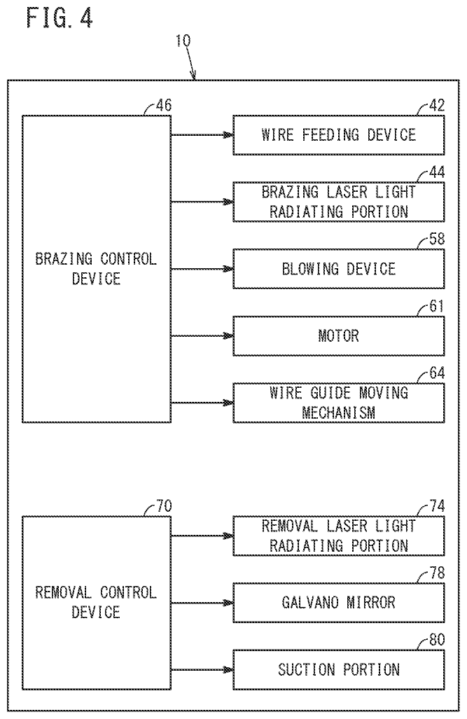

The wire guide portion 36 is attached to the front surface of the unit case 52 via a wire guide moving plate 62, which is described in detail further below. A blowing pipe 56 and a blowing device 58 (see FIG. 4) that blows argon gas through the blowing pipe 56 are attached to the wire guide portion 36. The blowing device 58 is controlled by the brazing control device 46.

In the present embodiment, the brazing laser light radiating unit for radiating the brazing laser light 44a toward the wire 50 is configured to include the brazing laser light radiating portion 44, the head body mirror 48, and the brazing unit mirror 54.

The wire guide portion 36 guides the wire 50 toward the prescribed position P1. The wire feeding portion that sends out the wire 50 to the prescribed position is formed by the wire feeding device 42 and the wire guide portion 36. In the present embodiment, the prescribed position P1 described above, which is the guidance destination of the wire 50, is the same as the irradiation position P2 of the brazing laser light 44a reflected by the brazing unit mirror 54 and radiated downward from the brazing unit 32.

The blowing pipe 56 is provided such that the blowing is performed from forward to backward in the progression direction, centered on the irradiation position P2 of the brazing laser light 44a (see FIG. 1). Furthermore, the blowing pipe 56 is provided such that the blowing is performed from right to left of the brazing device 10, centered on the irradiation position P2 of the brazing laser light 44a (see FIG. 2). In the present embodiment, the blowing portion that blows toward the irradiation position P2 of the brazing laser light 44a is configured to include the blowing pipe 56 and the blowing device 58.

Foreign matter such as soot adhering to or generated on the surface of the side panel 18 and the surface of the roof panel 20 when the side panel 18 and the roof panel 20 are bonded is blown away in the direction toward the removal laser head 16 due to the blowing from the blowing pipe 56.

The brazing unit rotating section 34 includes a rotating board 60 rotatably attached to the front surface of the head body case 40, and a motor 61 that rotates the rotating board 60 (see FIG. 4). The driving of the motor 61 is controlled by the brazing control device 46. A hole (not shown in the drawings) for passing the brazing laser light 44a reflected forward by the head body mirror 48 is formed in the rotating board 60.

The wire guide moving portion 38 includes the wire guide moving plate 62 that is attached to the front surface of the unit case 52 of the brazing unit 32 in a manner to be able to move parallel to the radiation direction of the brazing laser light 44a. The wire guide portion 36 is attached to the front surface of the wire guide moving plate 62.

Furthermore, the wire guide moving portion 38 includes a wire guide moving mechanism 64 formed by a motor, gear, or the like that moves the wire guide moving plate 62 (see FIG. 4), and the wire guide moving mechanism 64 is controlled by the brazing control device 46. By moving the wire guide moving plate 62 with the wire guide moving mechanism 64, the wire guide portion 36 moves parallel to the radiation direction of the brazing laser light 44a.

In the present embodiment, the brazing head 14 is configured to be heavier than the removal laser head 16. Furthermore, since the first arm 22a to fourth arm 22d of the robot 22 are configured in a cantilevered manner with the fourth arm 22d on the root side, the maximum moment caused by the load is placed on the root portion of the fourth arm 22d.

In the present embodiment, the first arm 22a holds the brazing head 14 to be on a side closer to this root portion than the removal laser head 16 (see FIG. 2). Therefore, compared to a case where the brazing head 14 is held on a side farther from the root portion than the removal laser head 16, the moment placed on each arm 22a to 22d can be reduced, and it is possible to increase the durability of each arm 22a to 22d.

### [Removal Laser Head]

The removal laser head 16 includes a removal laser head body 66 and a removal laser unit 68. The removal laser head 16 is arranged farther left than the brazing head 14. That is, the brazing head 14 and the removal laser head 16 are arranged at positions offset from each other in the left-right direction (see FIG. 2).

The removal laser head body 66 is attached to a rear side portion of the device attachment board 28, and includes a removal control device 70 (see FIG. 4).

The removal laser unit 68 is attached to the removal laser head body 66, and includes a removal laser case 72. A removal laser light radiating portion 74 that radiates the removal laser light 74a diagonally downward and forward (D5 direction), as well as a first mirror 76 and a Galvano mirror 78 acting as a second mirror, are arranged inside the removal laser case 72. The removal laser light radiating portion 74 and the Galvano mirror 78 are controlled by the removal control device 70.

The first mirror 76 changes, by 90°, the direction of the removal laser light 74a, which is radiated diagonally downward (D5 direction) from the removal laser light radiating portion 74, and reflects this removal laser light 74a toward the Galvano mirror 78 arranged diagonally forward from the first mirror 76. The Galvano mirror 78 reflects the removal laser light 74a, which has been reflected diagonally forward by the first mirror 76, toward the surface of the roof panel 20. When the removal laser light 74a is radiated toward the roof panel 20, the foreign matter such as soot adhered to the surface of the roof panel 20 is removed.

The Galvano mirror 78 has a widely known structure formed of a pair of reflective mirrors having variable reflection angles, and is therefore shown in a simplified manner in FIG. 1 and the like. For the sake of convenience, the Galvano mirror 78 is described as being formed to be capable of rotating or swinging around a first axis 78a oriented in the left-right direction and a second axis 78b oriented in the front-rear direction.

Due to the periodic swinging of the Galvano mirror 78 around the second axis 78b, the removal laser light 74a can be made to scan across a prescribed width in the left-right direction.

Due to the rotation of the Galvano mirror 78 around the first axis 78a, the reflection angle of the removal laser light 74a can be changed. When the Galvano mirror 78 is at the rotational position around the first axis 78a shown in FIG. 1, the removal laser light 74a reflected by the first mirror 76 has its direction changed by 90° by the Galvano mirror 78 and is reflected in the D5 direction that forms an angle θ relative to the vertical direction D7, to irradiate an irradiation position P3.

The Galvano mirror 78 is held at this rotational position from when the brazing device 10 is at the starting end position of the bonding portion to immediately before the brazing device 10 reaches the finishing end position of the bonding portion, in other words, from the bonding starting end of the workpiece to immediately before the bonding finishing end of the workpiece. When the brazing device 10 reaches the finishing end position of the bonding portion, the Galvano mirror 78 is changed to another rotational position. At this other rotational position, the angle formed between the removal laser light 74a entering the Galvano mirror 78 and the removal laser light 74a emitted from the Galvano mirror 78 is smaller than 90°.

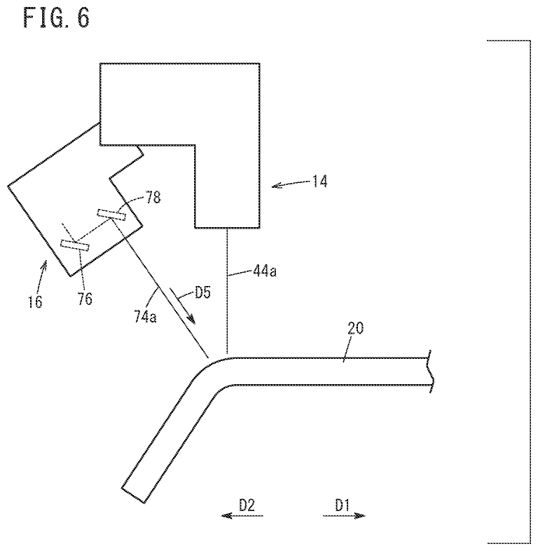

The angle θ described above is preferably set to a value in a range of 30° to 55°. In this way, it is possible to favorably remove the foreign matter at the starting end of the bonding portion in particular. This is because the starting end of the bonding portion between the side panel 18 and the roof panel 20 has a curved or bent shape that bends downward (see FIG. 6).

By inclining the radiation direction of the removal laser light 74a (D5 direction) by the angle θ relative to the vertical direction D7, which is the radiation direction of the brazing laser light 44a, the irradiation position P3 of the removal laser light 74a can be positioned close behind the irradiation position P2 of the brazing laser light 44a. In this way, it is possible to favorably remove the foreign matter not just from the starting end of the bonding portion, but also from a wide range of the bonding portion that can include the curved portion. The distance between the irradiation position P2 of the brazing laser light 44a and the irradiation position P3 of the removal laser light 74a is preferably approximately from 5 mm to 30 mm, for example, to make this positions as close to each other as possible.

By making the irradiation position P2 of the brazing laser light 44a and the irradiation position P3 of the removal laser light 74a as close as possible, the movement distance of the brazing device 10 needed to perform bonding from the starting end to the finishing end of the bonding portion and remove the foreign matter can be made as short as possible.

In the present embodiment, the removal laser light radiating unit for radiating the removal laser light 74a, which removes foreign matter adhered to the surface of the roof panel 20, toward the surface of the roof panel 20 is configured to include the removal laser light radiating portion 74, the first mirror 76, and the Galvano mirror 78.

A suction portion 80 is provided on the bottom portion of the removal laser case 72. The suction portion 80 sucks up the foreign matter that has been removed by the removal laser light 74a, and the driving of the suction portion 80 is controlled by the removal control device 70.

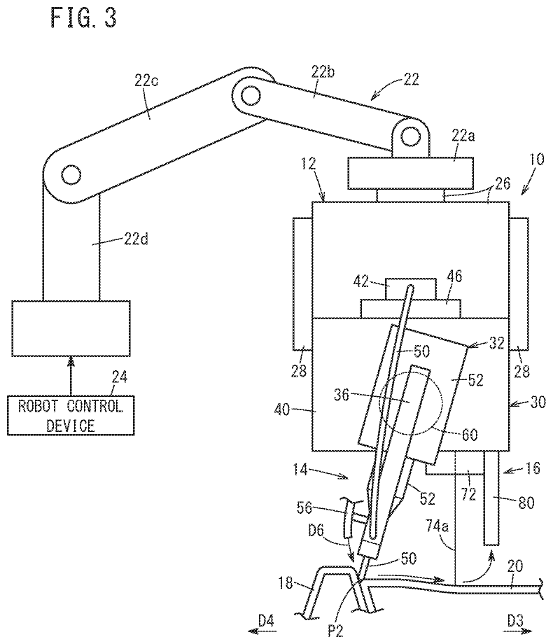

As shown in FIG. 3, in a case of bonding a portion of the side panel 18 that protrudes father upward than the roof panel 20, for example, the brazing control device 46 drives the motor 61 to rotate the rotating board 60 to which the unit case 52 of the brazing unit 32 is attached.

When the brazing unit 32 rotates due to the rotation of the rotating board 60, the wire 50 also rotates. Then, the up-down direction of the wire guide portion 36 is adjusted by the wire guide moving portion 38 as needed. Since the load placed on the motor 61 increases when the wire 50 contacts the bonding portion, the brazing control device 46 detects that the wire 50 has contacted the bonding portion by detecting an increase in the load of the motor 61, and stops the driving of the motor 61 so that bonding is performed at this position.

### [Panel Bonding]

When bonding the side panel 18 and the roof panel 20 with the brazing device 10, first, the robot control device 24 drives the robot 22 to set the brazing device 10 at the starting end position of the bonding portion.

At this time, the brazing device 10 is supported by the first arm 22a of the robot 22 with the posture shown in FIGS. 1 and 2. Furthermore, the Galvano mirror 78 of the removal laser unit 68 is set at a prescribed rotational position around the first axis 78a, such that the laser light entering from the first mirror 76 can be reflected in the diagonally downward D5 direction.

Next, the robot control device 24 drives the robot 22 to move the brazing device 10 in the progression direction along a prescribed route for bonding the side panel 18 and the roof panel 20.

In accordance with the movement of the brazing device 10, the brazing control device 46 drives the wire feeding device 42 to feed the wire 50 and also drives the brazing laser light radiating portion 44 and the blowing device 58.

Furthermore, the removal control device 70 drives the removal laser light radiating portion 74, the Galvano mirror 78, and the suction portion 80. The Galvano mirror 78 is periodically swung around the second axis 78b to make the removal laser light 74a scan in the left-right direction.

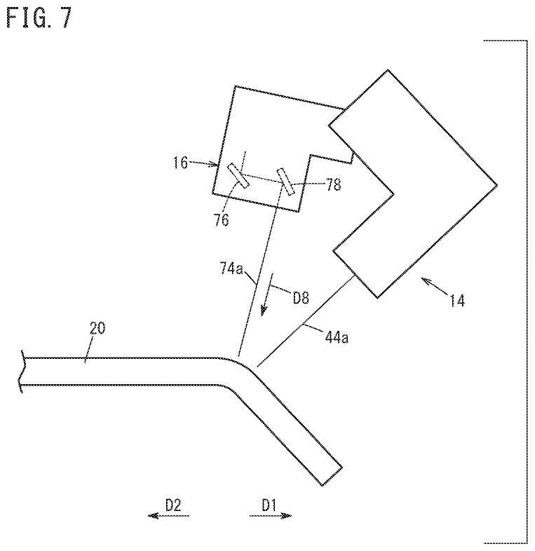

When the brazing device 10 reaches the finishing end position of the bonding portion, the robot control device 24 drives the arms 22a to 22d of the robot 22 to incline the brazing device 10 such that the bottom portion of the brazing device 10 is positioned farther backward in the progression direction than the upper portion thereof, as shown in FIG. 7. At the same time, the removal control device 70 rotates the Galvano mirror 78 around the first axis 78a, to make the angle formed between the removal laser light 74a entering the Galvano mirror 78 and the removal laser light 74a emitted from the Galvano mirror 78 be less than 90°.

Due to the inclination of the brazing device 10 and the rotation of the Galvano mirror 78 as described above, the removal laser light 74a reflected by the Galvano mirror 78 proceeds diagonally downward and backward in the progression direction (D8 direction). The removal laser light 74a irradiates the foreign matter near the finishing end of the bonding portion, and this foreign matter is favorably removed. This is because the finishing end of the bonding portion between the side panel 18 and the roof panel 20 has a bent or curved shape that bends downward.

### [Brazing Laser Light Radiation Step]

The brazing laser light radiating portion 44 radiates the brazing laser light 44a downward toward the head body mirror 48. The brazing laser light 44a radiated from the brazing laser light radiating portion 44 enters the head body case 40 and is reflected forward toward the brazing unit mirror 54 by the head body mirror 48.

The brazing laser light 44a reflected forward by the head body mirror 48 enters the unit case 52 of the brazing unit 32 and is reflected downward in the vertical direction by the brazing unit mirror 54, to irradiate the irradiation position P2.

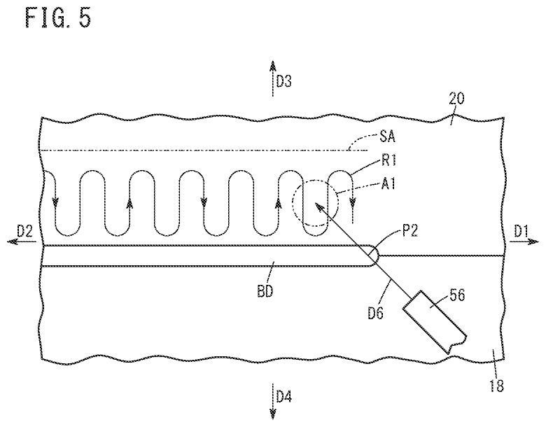

Due to being irradiated with the brazing laser light 44a, the wire 50 sent out to the prescribed position P1 of the bonding portion is melted. When the brazing device 10 moves and the melted portion of the wire 50 is no longer irradiated with the brazing laser light 44a, the melted portion of the wire 50 solidifies to form the bead BD, and the side panel 18 and the roof panel 20 are bonded (see FIG. 5). The wire 50 is omitted from FIG. 5.

The blowing device 58 blows argon gas through the blowing pipe 56. The argon gas passed through the blowing pipe 56 is blown toward the irradiation position P2 of the brazing laser light 44a. Due to this blowing, the foreign matter such as soot generated in the step of forming the bead BD is blown away in the blowing direction D6 (see FIG. 5). The foreign matter that has been blown away adheres to a foreign matter adhesion area A1 of the roof panel 20, indicated by a two-dot chain line in FIG. 5. In the present embodiment, the gas blown by the blowing device 58 is argon gas, but may be another inert gas or the like.

### [Removal Laser Light Radiation Step]

The removal laser light radiating portion 74 radiates the removal laser light 74a diagonally downward and forward (D5 direction) toward the first mirror 76. The removal laser light 74a radiated from the removal laser light radiating portion 74 is reflected diagonally forward toward the Galvano mirror 78 by the first mirror 76.

The Galvano mirror 78 reflects the incident removal laser light 74a diagonally downward and forward (D5 direction), and makes the removal laser light 74a scan in the left-right direction. In accordance with the movement of the brazing device 10 in the progression direction, the Galvano mirror 78 also moves in the progression direction. That is, since the Galvano mirror 78 makes the removal laser light 74a scan in the left-right direction while moving in the progression direction, the scanning route R1 of the removal laser light 74a becomes a scanning route such as shown in FIG. 5, and it is possible to perform uniform irradiation within the scanning region SA.

The removal laser light 74a may also scan over the bead BD, in which case an oxide film formed on the bead BD may be removed by the removal laser light 74a.

When the foreign matter adhered to the foreign matter adhesion area A1 of the roof panel 20 is irradiated with the removal laser light 74a within the scanning region SA, the foreign matter is blown away or absorbs the energy of the removal laser light 74a. When the energy of the removal laser light 74a is absorbed by the foreign matter and changed to thermal energy, the foreign matter becomes plasma, and therefore it is possible to remove the foreign matter through ablation.

The suction portion 80 sucks up the foreign matter that has been blown away from the roof panel 20 by the removal laser light 74a. Due to this, the removed foreign matter can be prevented from re-adhering to the roof panel 20.

In the present embodiment, the radiation direction of the removal laser light 74a is inclined by the given angle θ relative to the radiation direction of the brazing laser light 44a, from the bonding starting end to immediately before the bonding finishing end, but instead, the radiation direction of the removal laser light 74a may be set to be the vertical direction D7 that is parallel to the radiation direction of the brazing laser light 44a, between the bonding starting end and the bonding finishing end.

According to the present embodiment, the foreign matter generated in the step of bonding the side panel 18 and the roof panel 20 using the brazing device 10 can be removed in the same step with the removal laser head 16 provided to the brazing device 10, and therefore it is possible to reduce the number of steps and the cost compared to a case where a foreign matter removal step is provided separately from the bonding step.

Furthermore, since the irradiation position P3 of the removal laser light 74a and the irradiation position P2 of the brazing laser light 44a can be made as close to each other as possible, the foreign matter can be favorably removed from a wide range of the bonding portion including the bonding end portions of the side panel 18 and the roof panel 20.

The brazing device and the brazing method according to the present invention are not limited to the above-described embodiments, and it goes without saying that various modifications could be adopted therein without departing from the essence and gist of the present invention.

1. A brazing device that bonds a workpiece by melting a brazing material at a prescribed position while moving in a progression direction, the brazing device comprising:
a brazing laser light radiating unit configured to radiate brazing laser light for melting the brazing material at the prescribed position; and
a removal laser light radiating unit configured to radiate removal laser light for removing foreign matter adhered to or generated on a surface of the workpiece when the workpiece is bonded, toward the foreign matter, wherein
a radiation direction of the removal laser light toward the workpiece is inclined by a prescribed angle relative to a radiation direction of the brazing laser light toward the workpiece, the prescribed angle bringing an irradiation position of the removal laser light closer to an irradiation position of the brazing laser light.

2. The brazing device according to claim 1, wherein
the prescribed angle is in a range from 30° to 55°.

3. The brazing device according to claim 1, wherein
a distance between the irradiation position of the removal laser light and the irradiation position of the brazing laser light is from 5 mm to 30 mm.

4. The brazing device according to claim 1, wherein
the removal laser light radiating unit is configured to allow the removal laser light to scan across a prescribed width in a left-right direction relative to the progression direction.

5. The brazing device according to claim 1, wherein
the removal laser light radiating unit includes a Galvano mirror configured to change an angle formed between the radiation direction of the brazing laser light and the radiation direction of the removal laser light.

6. The brazing device according to claim 1, comprising
a suction portion configured to suck up the foreign matter removed by the removal laser light.

7. The brazing device according to claim 1, comprising
a blowing portion configured to blow toward the irradiation position of the brazing laser light.

8. A brazing method for bonding a workpiece by melting a brazing material at a prescribed position while moving in a progression direction, the brazing method comprising:
a brazing laser light radiating step of radiating brazing laser light for melting the brazing material at the prescribed position; and
a removal laser light radiating step of radiating removal laser light for removing foreign matter adhered to or generated on a surface of the workpiece when the workpiece is bonded, toward the foreign matter, wherein
at least at a bonding starting end of the workpiece, a radiation direction of the removal laser light toward the workpiece is inclined by a prescribed angle relative to a radiation direction of the brazing laser light toward the workpiece, the prescribed angle bringing an irradiation position of the removal laser light closer to an irradiation position of the brazing laser light.

9. The brazing method according to claim 8, wherein
from the bonding starting end of the workpiece to immediately before a bonding finishing end of the workpiece, the radiation direction of the removal laser light toward the workpiece is inclined by a prescribed angle relative to the radiation direction of the brazing laser light toward the workpiece, the prescribed angle bringing the irradiation position of the removal laser light closer to the irradiation position of the brazing laser light.

10. The brazing method according to claim 8, wherein
at a bonding finishing end of the workpiece, an angle formed between the radiation direction of the brazing laser light and the radiation direction of the removal laser light is changed.
